(19) United States
(12) Patent Application Publication
(10) Pub. No.: US 2012/0018046 A1
(43) Pub. Date: Jan. 26, 2012

(54) METHOD OF MANUFACTURING COMPRESSED WOOD PRODUCT

(75) Inventors: Tatsuya SUZUKI, Tokyo (JP); Toshifumi NAKANO, Tokyo (JP); Tatsuo KITAZAWA, Tokyo (JP)

(73) Assignee: OLYMPUS CORPORATION, Tokyo (JP)

(21) Appl. No.: 13/249,869

(22) Filed: Sep. 30, 2011

Related U.S. Application Data
(63) Continuation of application No. PCT/JP2010/055933, filed on Mar. 31, 2010.

(30) Foreign Application Priority Data
Apr. 2, 2009 (JP) 2009-090404

(51) Int. Cl. B27M 1/02

(52) U.S. Cl. 144/380; 144/359

(57) ABSTRACT

A method of manufacturing a compressed wood product that is obtained by compressing and forming a wooden piece, includes applying a compressive force to a blank piece that is cut out from raw wood and has a predetermined shape while sandwiching the blank piece between a pair of metal molds; and dividing the compressed blank piece into a plurality of portions by cutting. A compression rate, at the compressing, of an area of the blank piece corresponding to a boundary of the portions divided at the dividing is higher than compression rates, at the compressing, of other areas of the blank piece. A width of the boundary is larger than a cut width that is obtained when the blank piece is cut at the dividing.

### CROSS-REFERENCE TO RELATED APPLICATIONS

This application is a continuation of PCT international application Ser. No. PCT/JP2010/055933 filed on Mar. 31, 2010 which designates the United States, incorporated herein by reference, and which claims the benefit of priority from Japanese Patent Application No. 2009-090404, filed on Apr. 2, 2009, incorporated herein by reference.

### BACKGROUND OF THE INVENTION

1. Field of the Invention

The present invention relates to a method of manufacturing a compressed wood product by compressing and forming a wooden piece into a predetermined three-dimensional shape.

2. Description of the Related Art

In recent years, wooden materials that are natural materials attract attention. With a wide variety of grain patterns, wood products made of wood exhibit individual features depending on positions of the raw wood from which the particular wood products are cut out. Such individual features of each wood product give it a unique quality. In addition, surface flaws and discolorations caused by a long-term use create unique textures which tend to evoke warm and familiar feeling in the user. Thus, the wooden material attracts attention as a material for products of uniqueness and taste which cannot be found in products made of synthetic resin or light metals. Techniques for molding wooden materials are also developing dramatically.

According to one conventionally known technique for molding wooden materials: a wooden board is softened with water absorption and compressed; the compressed wooden board is cut along a direction substantially parallel with a direction in which the compressive force is applied, whereby a primary fixed product with a sheet-like shape is obtained; and the primary fixed product is deformed into a desired three-dimensional shape under heat and moisture (for example, see Japanese Patent No. 3078452). Further, according to another conventional technique, a softened wooden sheet is compressed and temporarily secured in a prepared mold and left in the mold until the wooden sheet recovers. Thus a wood product with a desired shape can be obtained (see, for example, Japanese Laid-open Patent Publication No. 11-77619).

### SUMMARY OF THE INVENTION

A method according to an aspect of the present invention is of manufacturing a compressed wood product that is obtained by compressing and forming a wooden piece, includes applying a compressive force to a blank piece that is cut out from raw wood and has a predetermined shape while sandwiching the blank piece between a pair of metal molds; and dividing the compressed blank piece into a plurality of portions by cutting. A compression rate, at the compressing, of an area of the blank piece corresponding to a boundary of the portions divided at the dividing is higher than compression rates, at the compressing, of other areas of the blank piece. A width of the boundary is larger than a cut width that is obtained when the blank piece is cut at the dividing.

According to the present invention, a compression rate means the value ΔR/R, which is the ratio of the decrease ΔR of the thickness of a wooden piece due to compression to the thickness R of the wooden piece before compression. Here, the domain of the compression rate is 0≦(ΔR/R)<1.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart that illustrates the outline of a method of manufacturing a compressed wood product according to a first embodiment of the present invention;

FIG. 2 is a diagram that illustrates the outline of a cutting-out process in the method of manufacturing a compressed wood product according to the first embodiment of the present invention;

FIG. 3 is a diagram that illustrates the outline of a compression process in the method of manufacturing a compressed wood product according to the first embodiment of the present invention and illustrates the configuration of metal molds;

FIG. 4 is a cross-section view taken along the line A-A illustrated in FIG. 3;

FIG. 5 is a cross-section view that illustrates the state where the deformation of a wooden piece is almost complete in the compression process in the method of manufacturing a compressed wood product according to the first embodiment of the present invention;

FIG. 6 is a partial enlarged view of the periphery of a first protruded portion illustrated in FIG. 5;

FIG. 7 is a perspective view that illustrates the configuration of a wooden piece after a drying process is complete in the method of manufacturing a compressed wood product according to the first embodiment of the present invention;

FIG. 8 is a diagram that illustrates the state before a heat shaping process is performed in the method of manufacturing a compressed wood product according to the first embodiment of the present invention;

FIG. 9 is a diagram that illustrates the state when the heat shaping process is being performed in the method of manufacturing a compressed wood product according to the first embodiment of the present invention;

FIG. 10 is a perspective view that illustrates the configurations of compressed wood products after the shaping process is complete in the method of manufacturing a compressed wood product according to the first embodiment of the present invention;

FIG. 11 is a perspective view that illustrates the configuration of a digital camera that uses, as an exterior cover, a compressed wood product manufactured by the method of manufacturing a compressed wood product according to the first embodiment of the present invention;

FIG. 12 is a diagram that illustrates the configurations of metal molds to be used in a compression process in a method of manufacturing a compressed wood product according to a modified example of the first embodiment of the present invention;

FIG. 13 is a diagram that illustrates the outline of a compression process in a method of manufacturing a compressed wood product according to a second embodiment of the present invention and illustrates the configurations of a blank piece and metal molds;

FIG. 14 is a cross-section view taken along the line B-B in FIG. 13;

FIG. 15 is a cross-section view that illustrates the state where the deformation of a wooden piece is almost complete in the compression process in the method of manufacturing a compressed wood product according to the second embodiment of the present invention;

FIG. 16 is a diagram that illustrates the outline of a division process in the method of manufacturing a compressed wood product according to the second embodiment of the present invention;

FIG. 17 is a diagram that illustrates the outline of a compression process in a method of manufacturing a compressed wood product according to a third embodiment of the present invention and illustrates the configurations of a blank piece and metal molds;

FIG. 18 is a cross-section view taken along the line C-C in FIG. 17;

FIG. 19 is a cross-section view that illustrates the state where the deformation of a wooden piece is almost complete in the compression process in the method of manufacturing a compressed wood product according to the third embodiment of the present invention; and

FIG. 20 is a perspective view that illustrates the configuration of a wooden piece after a drying process is complete in the method of manufacturing a compressed wood product according to the third embodiment of the present invention.

### DETAILED DESCRIPTION OF THE PREFERRED EMBODIMENTS

An explanation is given of preferred embodiments (hereinafter, referred to as “embodiments”) of the present invention with reference to the accompanying drawings. The drawings that are referred to in the following descriptions are schematically illustrated. When the same object is illustrated in a different drawing, its dimension, scale, or the like may be different.

### First Embodiment

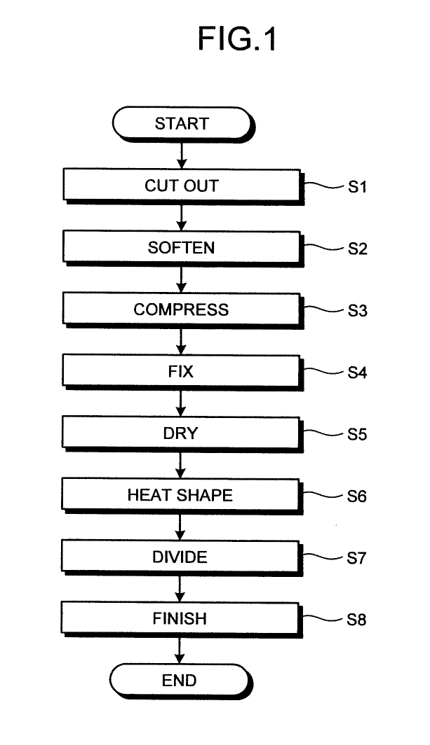

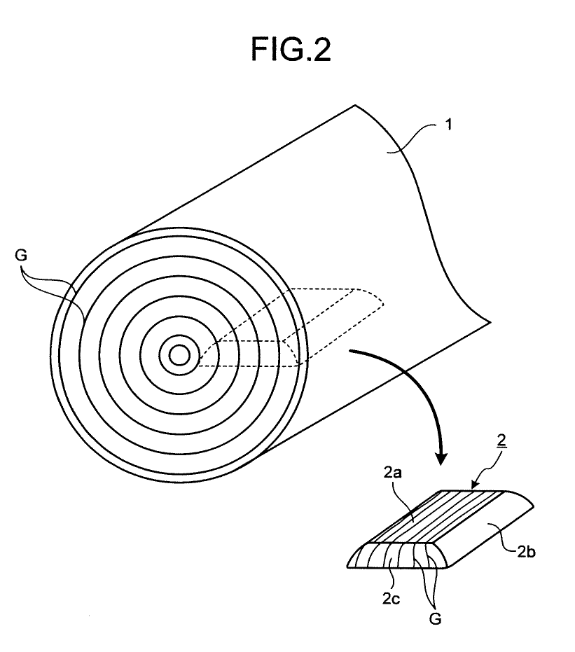

FIG. 1 is a flowchart that illustrates the outline of a process in a method of manufacturing a compressed wood product according to a first embodiment of the present invention. First, a blank piece with a predetermined shape is cut out from raw wood (Step S1). FIG. 2 is a diagram that schematically illustrates the outline of a cutting-out process. In the cutting-out process, a substantially dish-shaped blank piece 2 is cut out, or the like, from raw wood 1, such as unprocessed wood, that is not in a compressed state. An appropriate material may be selected as the raw wood 1 from hinoki cypress, hiba cedar, paulownia, Japanese cedar, pine, cherry, zelkova, ebony wood, red sandalwood, bamboo, teak, mahogany, rosewood, and the like.

The blank piece 2 includes a main plate portion 2a that has a flat-plate shape with a substantially rectangular surface; two side plate portions 2b that each extend and curve with respect to the main plate portion 2a from the two opposing long sides of the surface of the main plate portion 2a, respectively; and two side plate portions 2c that each extend and curve with respect to the main plate portion 2a from the two opposing short sides of the surface of the main plate portion 2a, respectively. The volume of the blank piece 2 includes an additional volume that corresponds to the volume that is lost due to the compression process described later. FIG. 2 illustrates a case where the blank piece 2 is a quarter-sawn timber, i.e., grain G of the blank piece 2 is substantially parallel to the fiber direction of the blank piece 2; however, this is merely an example. Specifically, a wooden piece that is cut out in the cutting-out process may be a plain-sawn timber, a timber with a butt end, or the like.

Next, the cut-out blank piece 2 is left for a predetermined time in a water-vapor atmosphere at a higher temperature and pressure than those in the atmospheric air so as to absorb an excessive amount of water so that the blank piece 2 becomes softened (Step S2). The water vapor has a temperature of about 100 to 230° C. and a pressure of about 0.1 to 3.0 MPa (megapascal). Such a water-vapor atmosphere can be produced by using, for example, a pressure vessel. If a pressure vessel is used, the blank piece 2 is left in the pressure vessel so as to be softened. Instead of leaving the blank piece 2 in a water-vapor atmosphere so as to be softened, the blank piece 2 may be softened by heating using a high-frequency electromagnetic wave, such as a microwave, after water is supplied to the surface of the blank piece 2, or the blank piece 2 may be softened by boiling.

Afterward, the softened blank piece 2 is compressed (Step S3). In the compression process, a compressive force is applied to the blank piece 2 while the blank piece 2 is sandwiched between a pair of metal molds in the same water-vapor atmosphere as that in the softening process so that the blank piece 2 is deformed into a predetermined three-dimensional shape. If the blank piece 2 is softened in the pressure vessel, the blank piece 2 may be continuously compressed in the pressure vessel.

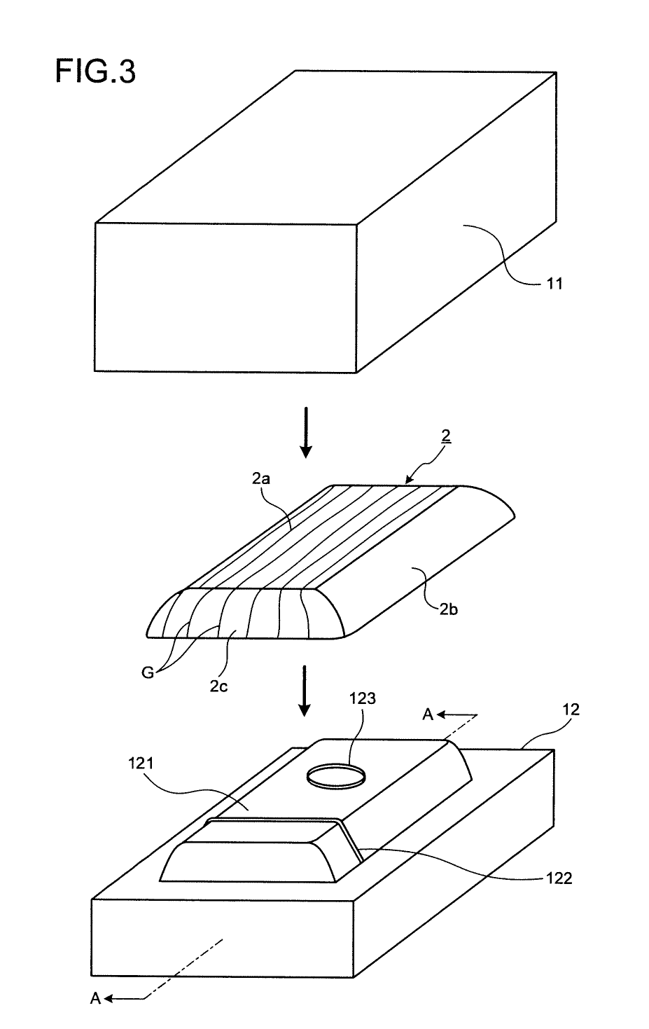

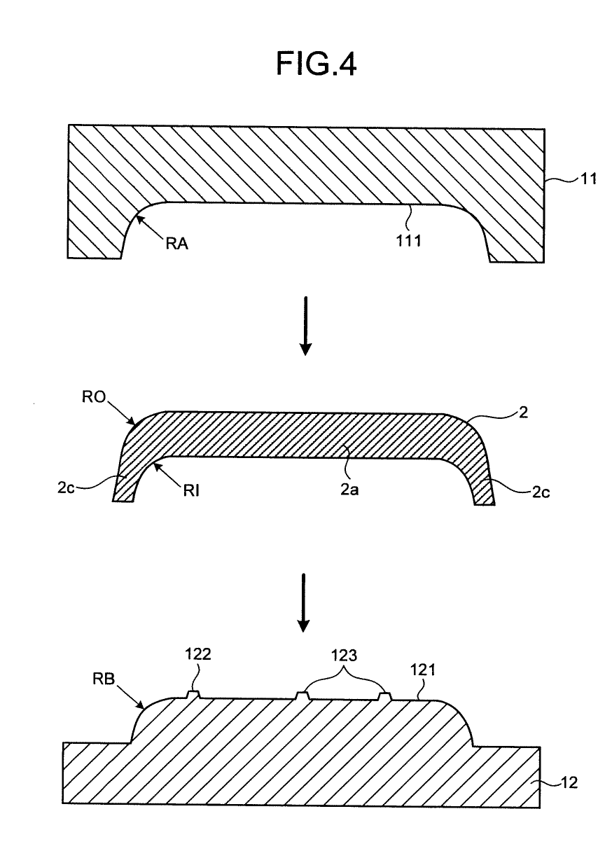

FIG. 3 is a diagram that illustrates the outline of the compression process and also illustrates the configuration of the main section of a pair of metal molds to be used in the compression process. FIG. 4 is a cross-section view taken along the line A-A illustrated in FIG. 3. As illustrated in FIGS. 3 and 4, the blank piece 2 is sandwiched between a pair of metal molds 11, 12, and a predetermined compressive force is applied.

The metal mold 11 is a cavity metal mold that applies a compressive force to the blank piece 2 from above during the compression process and that includes a smooth-surface depression 111 that is brought into contact with the protruded outer surface of the blank piece 2. If the surface of the curved area of the main plate portion 2a up to the side plate portion 2c that is opposed to the metal mold 11 has a curvature radius RO, and if the surface of the depression 111 that is brought into contact with the above surface has a curvature radius RA, the two curvature radii RO, RA satisfy a relation RO>RA.

Conversely, the metal mold 12 is a core metal mold that applies a compressive force to the blank piece 2 from below during the compression process and that includes a protrusion 121 that is brought into contact with the depressed inner surface of the blank piece 2. If the surface of the curved area of the main plate portion 2a up to the side plate portion 2c that is opposed to the metal mold 12 has a curvature radius RI, and if the surface of the protrusion 121 that is brought into contact with the above surface has a curvature radius RB, the two curvature radii RI, RB satisfy a relation RI>RB.

A first protruded portion 122 and a second protruded portion 123 are formed on the protrusion 121. The first protruded portion 122 is protruded along the transverse direction of the surface in the form of a line, and the second protruded portion 123 is protruded from substantially the middle of the surface in the form of a ring. The widths of the first protruded portion 122 and the second protruded portion 123 are nearly equal to and slightly larger than the cut width that is obtained when cutting is performed in the division process described later. The first protruded portion 122 is protruded by the same amount as the second protruded portion 123. If a plurality of protruded portions is formed on the surface of a metal mold, the amount each protruded portion is protruded may be changed in accordance with a condition such as the shape of a blank piece.

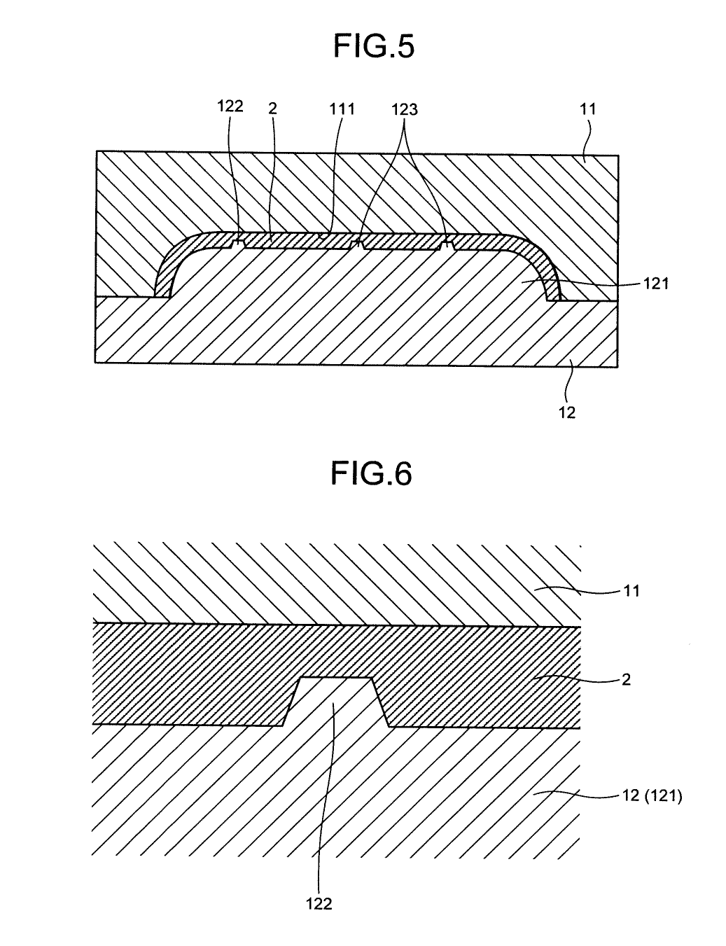

After sandwiching the blank piece 2, the metal molds 11, 12 are clamped together by an undepicted mold clamping device. FIG. 5 is a diagram that illustrates the state where the clamped metal molds 11, 12 apply a compressive force to the blank piece 2 and that illustrates the state where the deformation of the blank piece 2 is almost complete. FIG. 6 is an enlarged view of the periphery of the first protruded portion 122. As illustrated in these figures, the blank piece 2 is subjected to a compressive force by the metal molds 11, 12 so as to be deformed into a three-dimensional shape that corresponds to the gap between the metal mold 11 and the metal mold 12 when the metal molds 11, 12 are clamped together. In the compression process, a compressive force is continuously applied to the blank piece 2 for a predetermined time (one to several tens of minutes, and more preferably five to ten minutes) in the state illustrated in FIG. 5. When the blank piece 2 is subjected to this compressive force, the areas of the blank piece 2 that are in contact with the first protruded portion 122 and the second protruded portion 123 become thinner and denser than the surrounding areas (see FIG. 6).

After the compression process is complete, a water vapor at a higher temperature than the above-described waver vapor is applied to the surroundings of the metal molds 11, 12 while the clamped state of the metal molds 11, 12 is maintained so that the shape of the blank piece 2 is fixed (Step S4). If the fixing process is to be performed in the pressure vessel, water vapor at a higher temperature than that in the compression process may be brought into the pressure vessel.

Next, the metal molds 11, 12 and the blank piece 2 are exposed into the atmospheric air so that the blank piece 2 is dried (Step S5). At that time, the clamped state of the metal molds 11, 12 may be released to separate the metal mold 11 or 12 from the blank piece 2 so that drying of the blank piece 2 is facilitated. Preferably, after the drying is complete, the thickness of the blank piece 2 is about 30 to 50% of the thickness of the blank piece 2 that is obtained before the compression, and, more preferably, the compression rates of the areas that are in contact with the first protruded portion 122 and the second protruded portion 123 are higher than the compression rates of the other areas by about 1 to 15%. This corresponds to the compression rate of the blank piece 2 being about 0.50 to 0.70. Hereinafter, the blank piece 2 for which the drying process has been completed is referred to as a “wooden piece 3”.

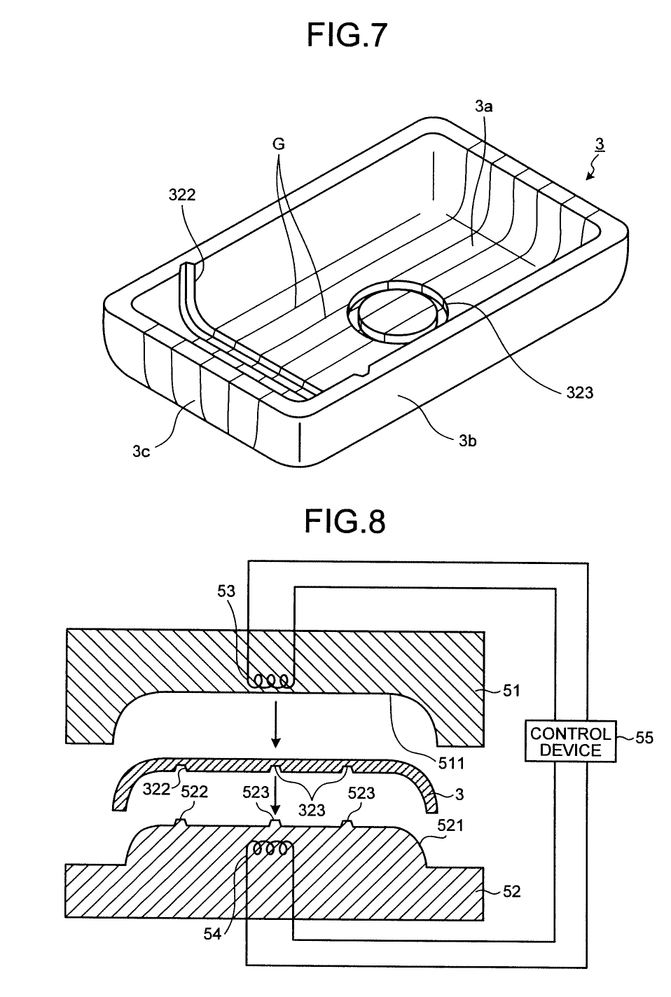

FIG. 7 is a perspective view that illustrates the configuration of the wooden piece 3. The wooden piece 3 illustrated in the same figure includes a main plate portion 3a and side plate portions 3b, 3c that correspond to the main plate portion 2a and the side plate portions 2b, 2c, respectively. A first groove 322 is formed on the depressed inner surface of the main plate portion 3a up to the side plate portion 3b, extending in the form of a line along the transverse direction of the wooden piece 3. A second groove 323 is formed in the form of a ring in substantially the middle of the inner surface of the main plate portion 3a. The first groove 322 and the second groove 323 are the areas that are compressed at a higher compression rate than the surrounding areas because they are in contact with the first protruded portion 122 and the second protruded portion 123, respectively. The thickness of the wooden piece 3 except for the first groove 322 and the second groove 323 is almost uniform.

Afterward, heat is applied to the wooden piece 3 in the atmospheric air while the wooden piece 3 is shaped (Step S6). FIG. 8 is a diagram that schematically illustrates the outline of a heat shaping process. In the heat shaping process, the wooden piece 3 is sandwiched between a pair of metal molds 51, 52 that are metal molds used for heat shaping.

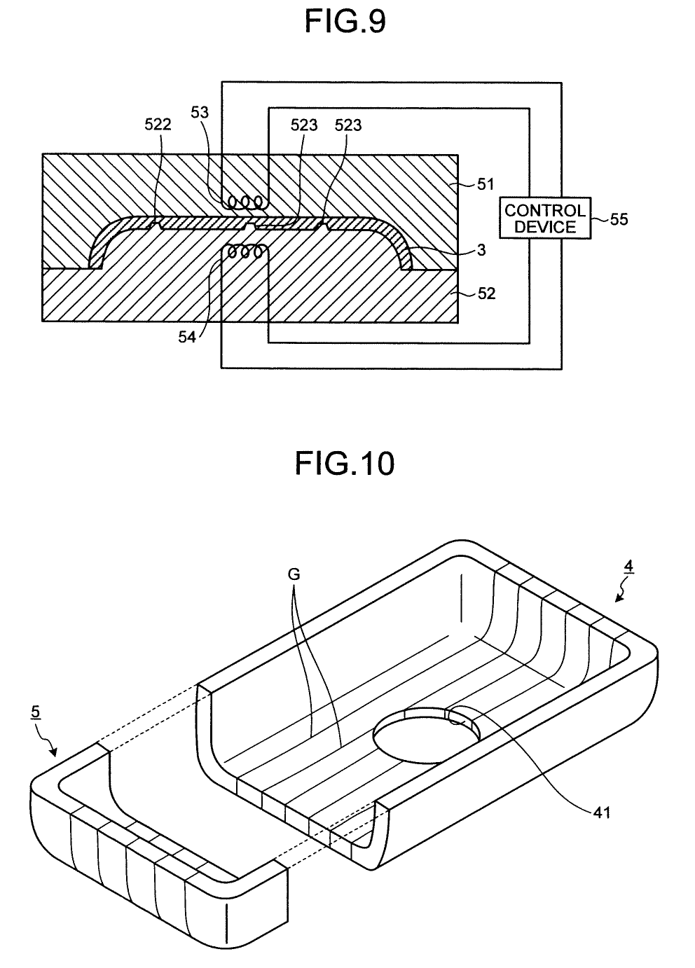

The metal mold 51 that is located above the wooden piece 3 in FIG. 8 includes a smooth-surface depression 511 that is brought into contact with the protruded surface of the wooden piece 3. Conversely, the metal mold 52 that is located under the wooden piece 3 in FIG. 8 includes a smooth-surface protrusion 521 that is brought into contact with the depressed surface of the wooden piece 3. As illustrated in FIG. 9, the shape of the gap between the metal mold 51 and the metal mold 52 that is obtained when the metal molds 51, 52 are clamped together for heat shaping corresponds to the shape of the wooden piece 3 after the shaping. It is preferable that the shape of the wooden piece 3 after the shaping is a shape that can be obtained by slightly deforming the shape of the wooden piece 3 before the heat shaping process. Thus, the shape of the wooden piece 3 does not significantly change before and after the heat shaping process so that the occurrence of a defect, such as a crack, can be prevented when the wooden piece 3 is shaped.

Heaters 53, 54, which produce heat, are mounted inside the metal molds 51, 52, respectively. The heaters 53, 54 are connected to a control device 55 that has a function of controlling temperatures. The heaters 53, 54 produce heat under the control of the control device 55 so as to apply heat to the metal molds 51, 52, respectively. The control device 55 controls the heaters 53, 54 such that the temperatures of the metal molds 51, 52 when sandwiching the wooden piece 3 are almost constant at about 150 to 200° C.

In the heat shaping process, a compression is performed such that the shape of the wooden piece 3 is hardly changed and the thickness of the wooden piece 3 becomes slightly thinner. As a result, the surface hardness of the wooden piece 3 is increased after the heat shaping process is performed. Furthermore, heating the wooden piece 3 allows the dimensional stability to be improved.

Next, the wooden piece 3 is cut along the first groove 322 and the second groove 323 so as to be divided into three wooden pieces (Step S7). Afterward, a trimming process is performed on the end surfaces of two of the three divided wooden pieces, but is not performed on the cylindrical wooden piece that is obtained by cutting along the second groove 323, so that a finishing is performed to form the two wooden pieces into final shapes (Step S8). FIG. 10 is a diagram that illustrates the configurations of two compressed wood products that are obtained by performing the processes from Steps S7 to S8 on the wooden piece 3. Out of two compressed wood products 4, 5 illustrated in the same figure, the larger compressed wood product 4 includes an opening 41 that is formed by cutting along the second groove 323. The groove widths of the first groove 322 and the second groove 323 correspond to the widths of the first protruded portion 122 and the second protruded portion 123. According to the first embodiment, the widths of the first protruded portion 122 and the second protruded portion 123 are nearly equal to and slightly larger than the cut width that is obtained when cutting is performed at the division process; therefore, the end surface that is obtained after cutting has a higher density than the other areas. As a result, the cross-section surface of a vessel or tracheid exposed through the end surface is crushed, which reduces the entry of water.

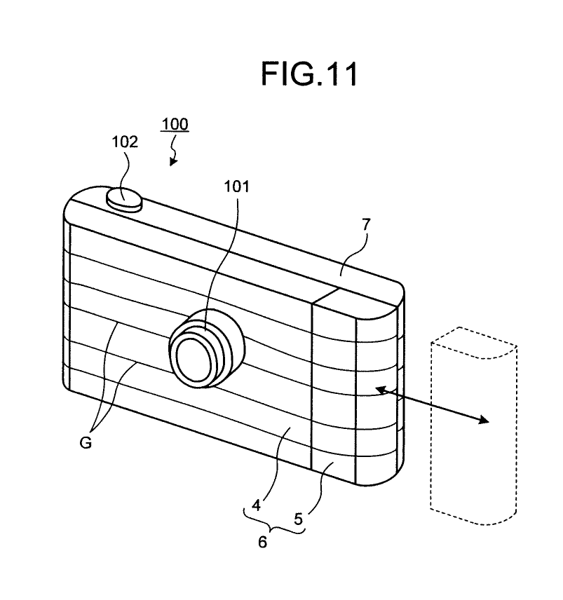

FIG. 11 is a diagram that illustrates an example of the application of the compressed wood products 4, 5 and is a perspective view that illustrates the configuration of a digital camera whose exterior cover is partially made of the compressed wood products 4, 5. A digital camera 100 illustrated in the same figure is covered by a front cover 6 that is obtained by combining the compressed wood products 4, 5 into their pre-division shape and by a rear cover 7 that is substantially bowl-shaped. The digital camera 100 includes an imaging unit 101 that is exposed through the opening 41 and a shutter button 102 that is exposed through an opening formed on the rear cover 7. The compressed wood product 5 is removable from the main body of the digital camera 100 and has a function as a cover for a battery. The compressed wood product 4 and the rear cover 7 are fixed to each other such that the end surfaces are closely attached to each other. Furthermore, a mechanism with which the compressed wood product 5 is removable from the main body of the digital camera 100 is mounted on the inner surface of the compressed wood product 5. In this case, it is more preferable that the thicknesses of the compressed wood products 4, 5 are about 0.8 to 2.0 mm. The rear cover 7 may be produced by using a wooden piece that is compressed and formed in the same manner as the front cover 6 or may be produced by using a different material. If the rear cover 7 is produced by using a compressed and formed wooden piece, a protruded portion corresponding to the edge of an opening through which the shutter button 102 is exposed may be formed on a metal mold.

A compressed wood product according to the first embodiment can be used as an exterior cover of an electronic device other than a digital camera. Furthermore, a compressed wood product according to the first embodiment can be used as a dish, various chassis, or the like.

According to the first embodiment of the present invention described above, the first protruded portion 122 and the second protruded portion 123 are formed at appropriate positions of the metal mold 12 out of the pair of the metal molds 11, 12 so that, when the blank piece 2 is compressed, the compression rates of the first groove 322 and the second groove 323 corresponding to the boundaries of portions to be divided by cutting after the compression are higher than the compression rates of the other areas and the widths of the first groove 322 and the second groove 323 are larger than the cut width; therefore, the density of the end surface obtained by cutting is higher than those of the other areas. Furthermore, because making the cut end surface have a high density as described above is performed in the compression process, it is not necessary to perform a separate process for preventing water from entering through the cut end surface. Thus, without increasing the number of processes, it is possible to prevent water from entering through an end surface of a wooden piece that is cut after being compressed.

Moreover, according to the first embodiment, the heat shaping process allows the boundary of portions to be divided to have a higher density, an increase in the surface hardness, and an improvement in the dimensional stability. For this reason, easy cutting can be performed using a cutting knife, a cutting error, such as fluff formation, can be prevented during processing, and processing accuracy can be improved. In addition, because the entry of water through a cut surface can be prevented, it is possible to avoid deformation, such as expansion or twisting, of a wooden piece due to water.

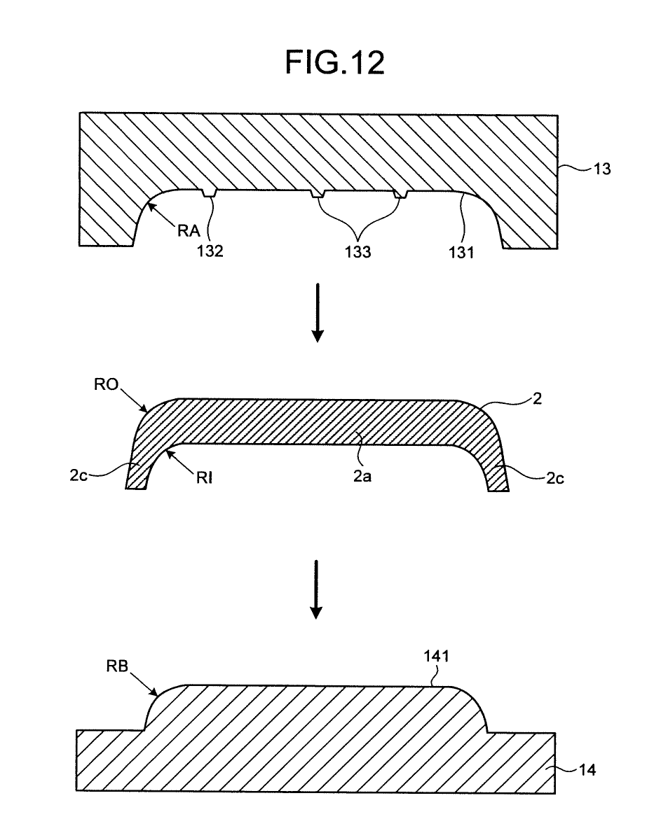

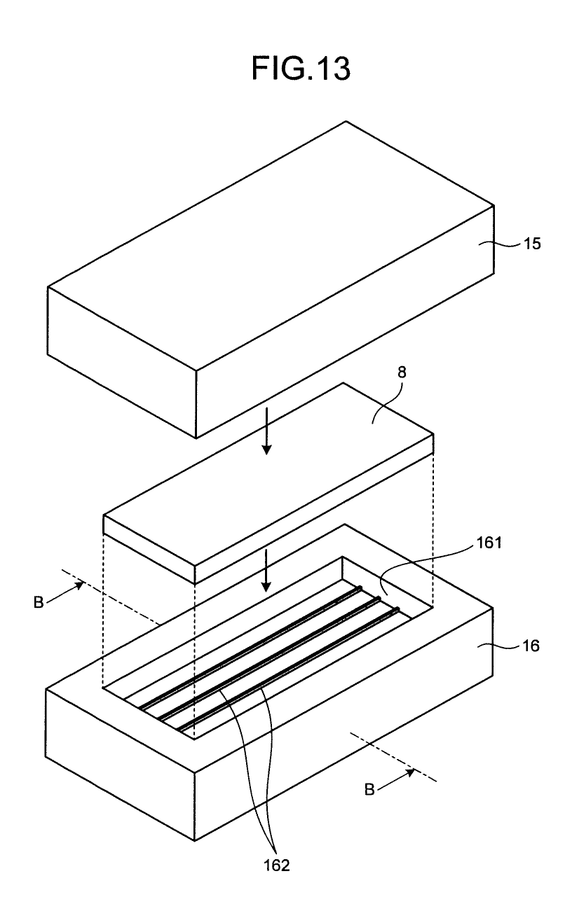

Although the first protruded portion 122 and the second protruded portion 123 are formed on the protrusion 121 of the metal mold 12, which is a core metal mold, according to the first embodiment, a first protruded portion 132 and a second protruded portion 133 may be formed on a depression 131 of a metal mold 13 that is a cavity metal mold as illustrated in FIG. 12. In this case, the surface of a protrusion 141 of a metal mold 14 that is a core metal mold may be simply a smooth surface; however, the compression process can be performed by using the metal mold 12 and the metal mold 13 as a pair of metal molds.

Furthermore, in the first embodiment, a method of heating a metal mold in the heat shaping process is not limited to the method described above. For example, a metal mold may be heated such that the metal mold is sandwiched between plates on which a heater is mounted, or a metal mold may be heated by using a heating furnace.

### Second Embodiment

A second embodiment of the present invention is characterized in that a plurality of flat-plate like compressed wood products is manufactured from a flat-plate like blank piece. The flow of a process in a method of manufacturing a compressed wood product according to the second embodiment is the same as that in the first embodiment described above (see FIG. 1).

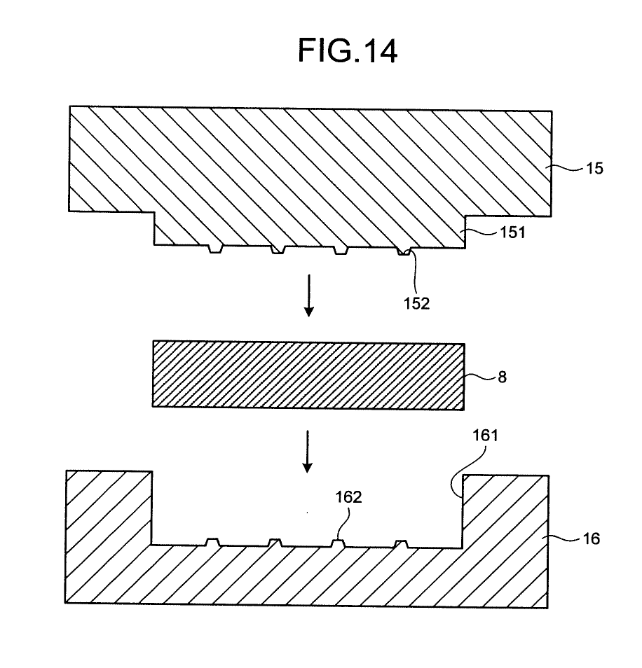

FIG. 13 is a diagram that illustrates the configurations of a pair of metal molds and a blank piece to be used in a compression process (Step S3). FIG. 14 is a cross-section view taken along the line B-B in FIG. 13. A metal mold 15 is a core metal mold that applies a compressive force to a flat-plate like blank piece 8 from above and that includes a protrusion 151. Protruded portions 152 are formed on the protrusion 151 at equal intervals in the transverse direction and are protruded in the form of a line in the longitudinal direction. A metal mold 16 is a cavity metal mold that applies a compressive force to the blank piece 8 from below and that includes a depression 161. The depression 161 includes protruded portions 162 that are formed at the positions opposed to the respective protruded portions 152. The widths of the protruded portions 152 and the protruded portions 162 are nearly equal to and slightly larger than the cut width that is obtained when cutting is performed in the division process described later.

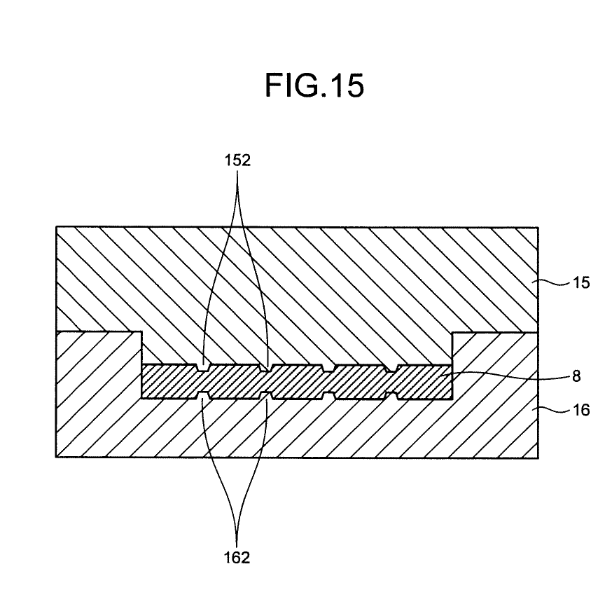

FIG. 15 is a diagram that illustrates the state where the metal molds 15, 16 are clamped together by an undepicted mold clamping device so as to apply a compressive force to the blank piece 8 and that illustrates the state where the deformation of the blank piece 8 is almost complete. In FIG. 15, the thickness of the blank piece 8 becomes thinner over all. The areas sandwiched between the protruded portions 152, 162 are thinner and denser than the other areas.

The compressed blank piece 8 is subjected to fixing (Step S4), drying (Step S5), and heat shaping (Step S6) in the same manner as the first embodiment. The processed blank piece 8 is hereinafter referred to as a “wooden piece 9”.

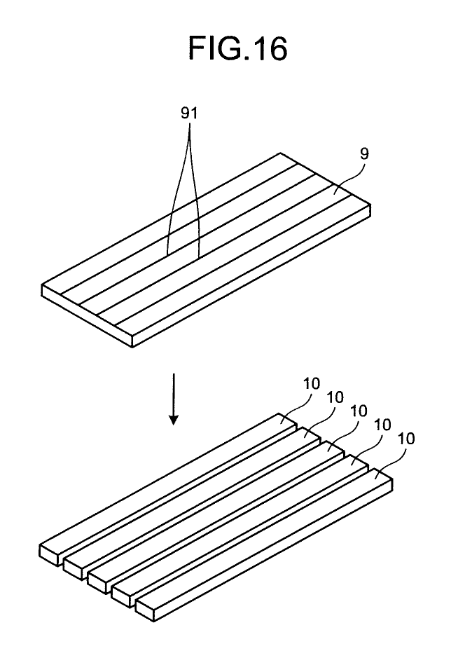

FIG. 16 is a diagram that illustrates the outline of the division process (Step S7) for the wooden piece 9. Grooves 91 extend along the longitudinal direction of the protruded portions 152, 162 during the compression process and are formed on the wooden piece 9 at equal intervals in the transverse direction. The wooden piece 9 is cut along the grooves 91 so that a plurality of plate-like wooden pieces 10 is formed. According to the second embodiment, the widths of the protruded portions 152 and 162 are nearly equal to and slightly larger than the cut width that is obtained when cutting is performed in the division process; therefore, the end surface obtained after cutting has a higher density than the other areas. As a result, the cross-section surface of a vessel or tracheid exposed through the end surface is crushed, which reduces the entry of water.

Afterward, the finishing process (Step S8) is performed to trim the end surface of the wooden piece 9 so that the compressed wood product is completed.

A compressed wood product manufactured as described above can be used as a building material such as a floor material or wall material.

According to the second embodiment of the present invention described above, the protruded portions 152, 162 are formed at the opposing positions of the metal molds 15, 16 that are a pair so that, when the blank piece 8 is compressed, the compression rate of the groove 91 corresponding to the boundary of portions to be divided by cutting after the compression is higher than the compression rates of the other areas and the width of the groove 91 is lager than the cut width; therefore, the density of the end surface obtained by cutting is higher than those of the other areas. Furthermore, because making the cut end surface have a high density as described above is performed in the compression process, it is not necessary to perform a separate process for preventing water from entering through the cut end surface. Thus, without increasing the number of processes, it is possible to prevent water from entering through an end surface of a wooden piece that is cut after being compressed.

Moreover, according to the second embodiment, the heat shaping process allows the boundary of portions to be divided to have a higher density, an increase in the surface hardness, and an improvement in the dimensional stability. Therefore, in the same manner as the first embodiment, cutting errors are avoided so as to improve processing accuracy, and the entry of water through a cut surface is prevented so as to avoid deformation, such as expansion or twisting, of a wooden piece due to water.

### Third Embodiment

A third embodiment of the present invention is characterized in that a protrusion is formed on a blank piece so that an area corresponding to the boundary of portions has a higher density than the other areas. The flow of a process in a method of manufacturing a compressed wood product according to the third embodiment is the same as the first embodiment described above (see FIG. 1).

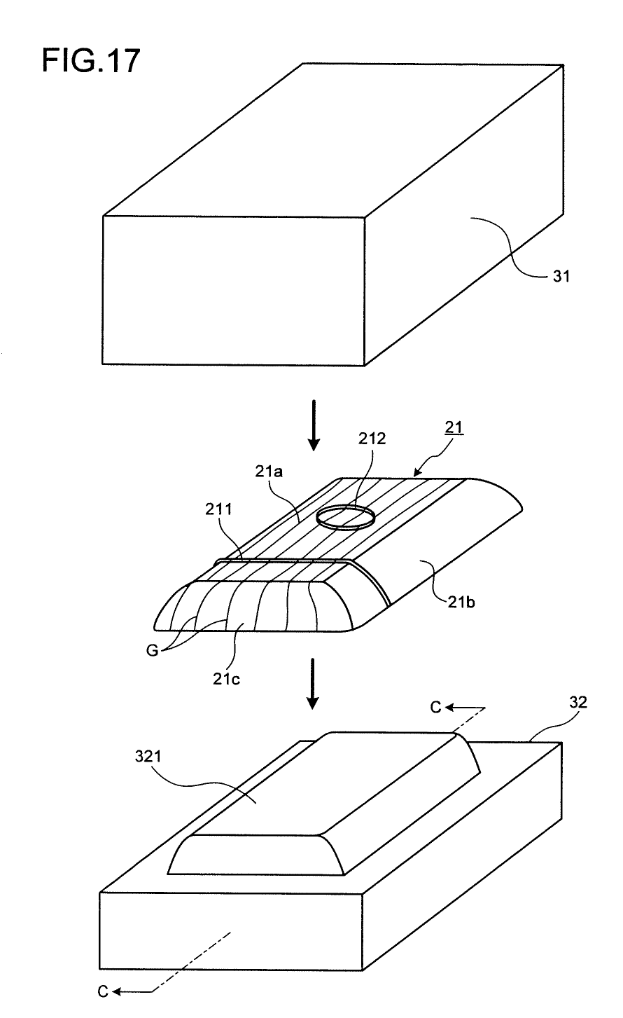

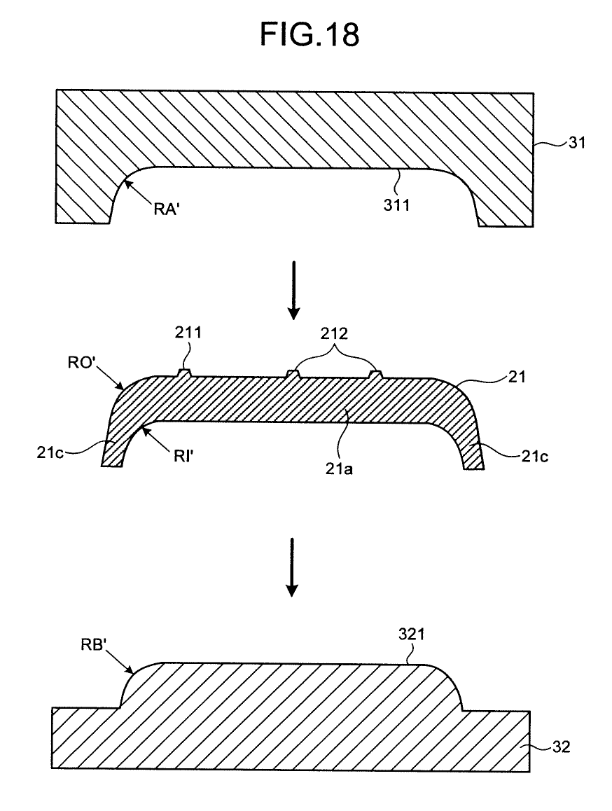

FIG. 17 is a diagram that illustrates the configuration of a blank piece and also illustrates the configuration of a pair of metal molds to be used in a compression process. FIG. 18 is a cross-section view taken along the line C-C illustrated in FIG. 17.

A blank piece 21 is substantially bowl-shaped in the same manner as the blank piece 2. The blank piece 21 includes a main plate portion 21a, two side plate portions 21b, and two side plate portions 21c. A first protruded portion 211 is formed on the outer surface of the main plate portion 21a up to the side plate portions 21b and is protruded in the form of a line along the transverse direction. Furthermore, a second protruded portion 212 is formed in almost the middle of the outer surface of the main plate portion 21a and is protruded in the form of a ring. The widths of the first protruded portion 211 and the second protruded portion 212 are nearly equal to and slightly larger than the cut width that is obtained when cutting is performed in the division process described later. The first protruded portion 211 is protruded by the same amount as the second protruded portion 212. If a plurality of protruded portions is formed on the surface of a blank piece, the amount each protruded portion is protruded may be changed in accordance with a condition such as the shape of a blank piece.

Next, an explanation is given of the configuration of metal molds. A metal mold 31 is a cavity metal mold that applies a compressive force to the blank piece 21 from above during the compression process and that includes a smooth-surface depression 311 that is brought into contact with the protruded outer surface of the blank piece 21. If the surface of the curved area of the main plate portion 21a up to the side plate portion 21c that is opposed to the metal mold 31 has a curvature radius RO′ and if the surface of the depression 311 that is brought into contact with the above surface has a curvature radius RA′, the two curvature radii RO′, RA′ satisfy a relation RO′>RA′.

A metal mold 32 is a core metal mold that applies a compressive force to the blank piece 21 from below during the compression process and includes a smooth-surface protrusion 321 that is brought into contact with the depressed inner surface of the blank piece 21. If the surface of the curved area of the main plate portion 21a up to the side plate portion 21c that is opposed to the metal mold 32 has a curvature radius RI′ and if the surface of the protrusion 321 that is brought into contact with the above surface has a curvature radius RB′, the two curvature radii RI′ RB′ satisfy a relation RP′>RB′.

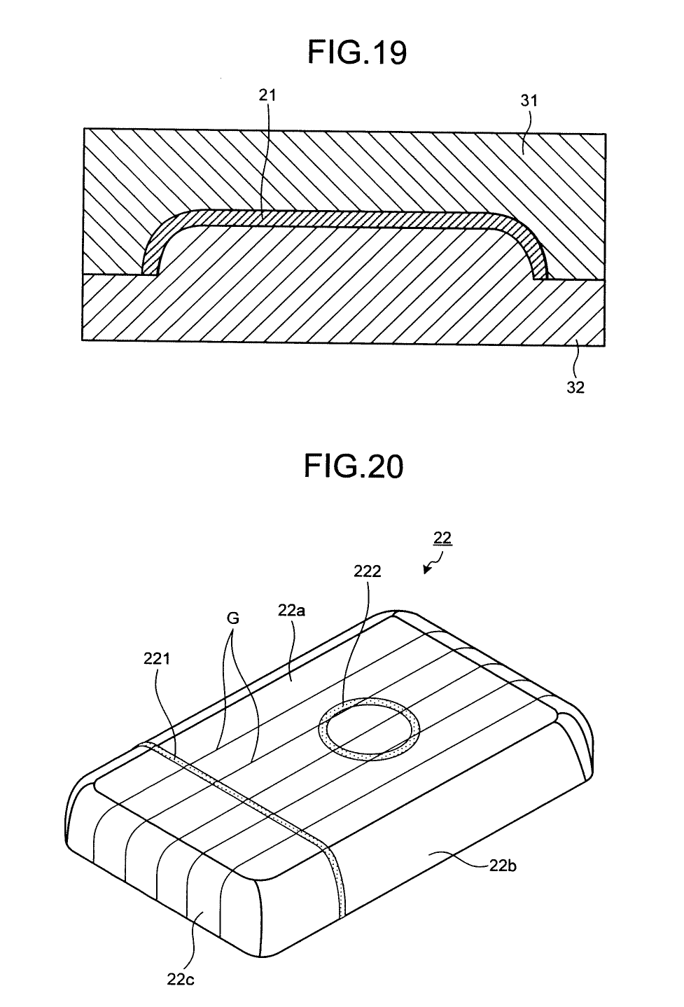

FIG. 19 is a diagram that illustrates the state where the metal molds 31, 32 are clamped together by an undepicted mold clamping device to apply compressive forces to the blank piece 21 and that illustrates the state where the deformation of the blank piece 21 is almost complete. The blank piece 21 is subjected to the compressive forces from the metal molds 31, 32 so as to be deformed into a three-dimensional shape that corresponds to the gap between the metal mold 31 and the metal mold 32 when the metal molds 31, 32 are clamped together. With the three-dimensional shape, because the surfaces of the depression 311 and the protrusion 321 are smooth surfaces, the areas where the first protruded portion 211 and the second protruded portion 212 are formed are compressed at a higher compression rate than the surrounding areas so as to have a high density.

The compressed blank piece 21 is subjected to fixing (Step S4), drying (Step S5), and heat shaping (Step S6) in the same manner as the first embodiment. The processed blank piece 21 is hereinafter referred to as a “wooden piece 22”.

FIG. 20 is a perspective view that illustrates the configuration of the wooden piece 22. The wooden piece 22 illustrated in the same figure includes a main plate portion 22a, side plate portions 22b and 22c that correspond to the main plate portion 21a, the side plate portions 21b and 21c, respectively. The area where the first protruded portion 211 was formed is a first high-density portion 221, and the area where the second protruded portion 212 was formed is a second high-density portion 222. In FIG. 20, the two high-density portions are schematically illustrated in boldface. The widths of the first high-density portion 221 and the second high-density portion 222 are nearly equal to those of the first protruded portion 211 and the second protruded portion 212.

After Step S6, the wooden piece 22 is cut along the first high-density portion 221 and the second high-density portion 222 so that the wooden piece 22 is divided into two portions (Step S7). According to the third embodiment, the widths of the first protruded portion 211 and the second protruded portion 212 are nearly equal to and slightly larger than the cut width that is obtained when cutting is performed in the division process. Therefore, the width of the first high-density portion 221 corresponding to the compressed area of the first protruded portion 211 and the width of the second high-density portion 222 corresponding to the compressed area of the second protruded portion 212 are nearly equal to and slightly larger than the cut width. Thus, the end surface that is obtained after cutting has a higher density than the other areas. As a result, the cross-section surface of a vessel or tracheid exposed through the end surface is crushed, which reduces the entry of water.

Afterward, a finishing process (Step S8) is performed so that compressed wood products 4, 5 illustrated in FIG. 10 are completed.

According to the third embodiment described above, the first protruded portion 211 and the second protruded portion 212 are formed on the surface of the blank piece 21 so that, when the blank piece 21 is compressed, the compression rates of the first high-density portion 221 and the second high-density portion 222, which each correspond to the boundary of portions to be cut and divided after being compressed, are higher than those of the other areas and the widths of the first high-density portion 221 and the second high-density portion 222 are larger than the cut width; therefore, the density of the end surface that is produced by cutting is higher than those of the other areas. Moreover, because making the cut end surface have a high density as described above is performed in the compression process, it is not necessary to perform a separate process for preventing water from entering through the cut end surface. Thus, without increasing the number of processes, it is possible to prevent water from entering through an end surface of a wooden piece that is cut after being compressed.

Furthermore, according to the third embodiment, the heat shaping process allows the boundary of portions to be divided to have a higher density, an increase in the surface hardness, and an improvement in the dimensional stability. Therefore, in the same manner as the first embodiment, cutting errors are avoided so as to improve processing accuracy, and the entry of water through a cut surface is prevented so as to avoid deformation, such as expansion or twisting, of a wooden piece due to water.

Although the first to third embodiments are described as preferred embodiments of the present invention, the present invention should not be limited to those embodiments. For example, the present invention can be applied to a case where a blank piece with a shape other than the above-described shape is compressed and formed.

Moreover, according to the present invention, depending on the shape or type of a wooden piece, after a compressed wooden piece is dried, a division process and a finishing process can be performed without performing a heat shaping process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a compressed wood product that is obtained by compressing and forming a wooden piece, the method comprising:
applying a compressive force to a blank piece that is cut out from raw wood and has a predetermined shape while sandwiching the blank piece between a pair of metal molds; and
dividing the compressed blank piece into a plurality of portions by cutting, wherein
a compression rate, at the compressing, of an area of the blank piece corresponding to a boundary of the portions divided at the dividing is higher than compression rates, at the compressing, of other areas of the blank piece, and
a width of the boundary is larger than a cut width that is obtained when the blank piece is cut at the dividing.

2. The method of manufacturing a compressed wood product according to claim 1, wherein at least one of the metal molds includes a protruded portion that is protruded from a surface that is brought into contact with the blank piece at the compressing, the protruded portion being at a position corresponding to the boundary of the portions.

3. The method of manufacturing a compressed wood product according to claim 1, wherein
an area of the blank piece corresponding to the boundary of the portions is thicker than other areas of the blank piece, and
surfaces of the metal molds that are brought into contact with the blank piece at the compressing are smooth surfaces.

4. The method of manufacturing a compressed wood product according to claim 1, further comprising shaping the blank piece into a predetermined shape while heating the blank piece in an atmospheric air before dividing the blank piece that is compressed at the compressing into a plurality of portions.

5. The method of manufacturing a compressed wood product according to claim 4, wherein the shaping includes heating a pair of heat-shaping metal molds corresponding to the predetermined shape and sandwiching the wooden piece using the pair of heated heat-shaping metal molds.

6. The method of manufacturing a compressed wood product according to claim 2, further comprising shaping the blank piece into a predetermined shape while heating the blank piece in an atmospheric air before dividing the blank piece that is compressed at the compressing into a plurality of portions.

7. The method of manufacturing a compressed wood product according to claim 3, further comprising shaping the blank piece into a predetermined shape while heating the blank piece in an atmospheric air before dividing the blank piece that is compressed at the compressing into a plurality of portions.

8. The method of manufacturing a compressed wood product according to claim 6, wherein the shaping includes heating a pair of heat-shaping metal molds corresponding to the predetermined shape and sandwiching the wooden piece using the pair of heated heat-shaping metal molds.

9. The method of manufacturing a compressed wood product according to claim 7, wherein the shaping includes heating a pair of heat-shaping metal molds corresponding to the predetermined shape and sandwiching the wooden piece using the pair of heated heat-shaping metal molds.
